(19) United States
(12) Patent Application Publication
(10) Pub. No.: US 2005/0200678 A1
(43) Pub. Date: Sep. 15, 2005

(54) Pressure development apparatus

(75) Inventors: Zhanjun Gao, Rochester, NY (US); Alphonse D. Camp, Rochester, NY (US); Eric J. Connor, Rochester, NY (US)

Correspondence Address: Mark G. Bocchetti;Eastman Kodak Company, Patent Legal Staff, 343 State Street, Rochester, NY, 14650-2201, US

(73) Assignee: Eastman Kodak Company

(21) Appl. No.: 10/799,267

(22) Filed: Mar. 12, 2004

(51) Int. Cl. B41J 2/01

(52) U.S. Cl. 347/104

(57) ABSTRACT

The present invention provides for a pressure development apparatus for an image forming device which includes a first pressure roller that has a width which is at least approximately equal to a media width of media to be developed and is adapted to apply pressure onto a surface of media to be developed. The development apparatus also includes at least a block-like member or a second roller mounted on top of the first pressure roller which is adapted to apply pressure onto the first pressure roller for the purpose of developing media to be developed. The block-like member or second pressure roller is effective to minimize any lateral deflection of the first pressure roller.

### FIELD OF THE INVENTION

The present invention relates to a pressure development apparatus for processing photosensitive media, wherein the photosensitive media includes a plurality of microcapsules that encapsulate imaging material such as coloring material.

### BACKGROUND OF THE INVENTION

Image forming devices are known in which media having a layer of microcapsules containing a chromogenic material and a photohardenable or photosoftenable composition, and a developer, which may be in the same or a separate layer from the microcapsules, is image-wise exposed. In these devices, the microcapsules are ruptured, and an image is produced by the differential reaction of the chromogenic material and the developer. More specifically, in these image-forming devices, after exposure and rupture of the microcapsules, the ruptured microcapsules release a color-forming agent, whereupon the developer material reacts with the color-forming agent to form an image. The image formed can be viewed through a transparent support or a protective overcoat against a reflective white support as is taught in, for example, U.S. Pat. No. 5,783,353 and U.S. Publication No. 2002/0045121 A1. Typically, the microcapsules will include three sets of microcapsules sensitive respectively to red, green and blue light and containing cyan, magenta and yellow color formers, respectively, as taught in U.S. Pat. No. 4,772,541. Preferably a direct digital transmission imaging technique is employed using a modulated LED print head to expose the microcapsules.

Conventional arrangements for developing the image formed by exposure in these image-forming devices include using spring-loaded balls, micro wheels, micro rollers or rolling pins, and heat from a heat source is applied after this development step to accelerate development.

The photohardenable composition in at least one and possibly all three sets of microcapsules can be sensitized by a photo-initiator such as a cationic dye-borate complex as described in, for example, U.S. Pat. Nos. 4,772,541; 4,772,530; 4,800,149; 4,842,980; 4,865,942; 5,057,393; 5,100,755 and 5,783,353.

The above describes micro-encapsulation technology that combines micro-encapsulation with photo polymerization into a photographic coating to produce a continuous tone, digital imaging member. With regard to the media used in this technology, a substrate is coated with millions of light sensitive microcapsules, which contain either cyan, magenta or yellow image forming dyes (in leuco form). The media further comprises a monomer and the appropriate cyan, magenta or yellow photo initiator that absorb red, green or blue light respectively. Exposure to light, after the induction period is reached, induces polymerization.

When exposure is made, the photo-initiator absorbs light and initiates a polymerization reaction, converting the internal fluid (monomer) into polymer, which binds or traps leuco dye from escaping when pressure is applied.

With no exposure, microcapsules remain soft and are easily broken, permitting all of the contained dye to be expelled into a developer containing binder and developed which produces the maximum color available. With increasing exposure, an analog or continuous tone response occurs until the microcapsules are completely hardened, to thereby prevent any dye from escaping when pressure is applied.

Conventionally, as describe above, in order to develop the image, pressure is applied across the image. As a final fixing step, heat is applied to accelerate color development and to extract all un-reacted liquid from the microcapsules. This heating step also serves to assist in the development of available leuco dye for improved image stability. Generally, pressure ruptured capsules (unhardened) expel lueco dye into the developer matrix.

An issue for microencapsulation imaging technology is the design of the mechanism that delivers a significantly high pressure to the image side of the media. To apply this pressure, two approaches are generally utilized. One approach employs spring-loaded micro wheels or ball processing (point processing) for compact low cost devices. The other approach which is generally applicable to high throughput devices employs large crushing rollers (line processing).

Pressure application devices which utilize spring-loaded micro wheels or ball processing are slow due to the fact that the development pitch is small and processing velocity is limited to reasonable bi-directional travel rates of the pressure application device. Pressure application devices which utilize large crushing rollers (line processing) are costly, and due to their structure, it is difficult to limit roller deflection under load of the large crushing roller.

### SUMMARY OF THE INVENTION

The present invention addresses the drawbacks noted above while at the same time provides for a low cost solution. The arrangement of the present invention offer the advantages of both types of approaches discussed above, i.e., low spring load and fast printing speed.

In a feature of the present invention, a small diameter roller is positioned to contact the media. The small diameter roller has a width that generally matches the width of the media. A block-like member or a larger diameter roller is mounted relative to the small diameter roller in a manner in which a force applied to the block-like member or the large diameter roller is transferred to the small diameter roller in contact with the media to be developed. This force is thereby converted to a pressure applied to the media via the small diameter roller that is sufficient to crush selected microcapsules. The advantage of the small diameter roller in combination with the block-like member or large diameter roller is that the small diameter roller can provide a desired maximum pressure to the media with a minimum force from the block-like member or the large diameter roller; and the block-like member or large diameter roller is effective to reduce or eliminate a lateral deflection of the small diameter roller during the pressure application process.

Therefore, the present invention offers the advantages of both point processing and line processing printers. It uses line processing so that the printing speed is fast and incorporates a roller with a small diameter so that a relatively low load is needed to provide the high pressure required for processing. In addition, large area line processing is possible (as with the large roller processor) without the need for high spring loading to minimize deflection under load, high motor torque or other high cost issues common to large roller processing devices.

The present invention therefore relates to a pressure development apparatus which comprises a pressure roller having a roller width which is at least approximately equal to a media width of media to be developed, with the pressure roller being adapted to apply a pressure onto a surface of media to be developed; and at least one block-like member mounted on top of the pressure roller, with the block-like member having at least one curved section adjacent to an outer circumference of the pressure roller that matches a curvature of said pressure roller and partially surrounds the outer circumference of the pressure roller.

The present invention further relates to a pressure development method that comprises the steps of exposing a photosensitive medium comprising a plurality of microcapsules that encapsulate imaging material to form a latent image; passing the photosensitive medium between a nip portion defined by at least one pressure roller and a backing member; and developing the photosensitive medium by applying pressure on a surface of the photosensitive medium by applying a force onto a block-like member located above the pressure roller that is transferred to the pressure roller, with the pressure being sufficient to rupture selected microcapsules to release imaging material, and the block-like member having at least one curved portion that matches a curvature of the at least one pressure roller and partially surrounds the at least one pressure roller.

The present invention further relates to a pressure development apparatus which comprises a first roller having a roller width that is at least approximately equal to a media width of media to be developed, with the first roller having a first diameter and being adapted to apply pressure onto a surface of media to be developed; and a second roller located above the first roller and having a second diameter which is larger than the first diameter of the first roller, with the second roller being adapted to equalize the pressure applied by the first roller in a width-wise direction and prevent a deflection of the first roller in the width-wise direction.

The present invention further relates to a pressure development apparatus which comprises a pressure roller having a roller width which is at least approximately equal to a media width of media to be developed, with the pressure roller being adapted to apply a pressure onto a surface of media to be developed; a first block-like member mounted on top of the pressure roller, with the first block-like member having a first curved section adjacent to an outer circumference of the pressure roller which matches a curvature of the pressure roller and partially surrounds the outer circumference of the pressure roller; a backing roller which forms a nip portion with the pressure roller for a passage of media to be developed there-between; and a second block-like member mounted adjacent to the backing roller, with the second block-like member having a second curved section adjacent to an outer circumference of the backing roller which matches a curvature of the backing roller and partially surrounds the outer circumference of the backing roller.

The present invention further relates to a pressure development apparatus which comprises a pressure roller having a roller width which is at least approximately equal to a media width of media to be developed, with the pressure roller being adapted to apply a pressure onto a surface of media to be developed; and at least one block-like member mounted on top of the pressure roller, with the block-like member adapted to provide a force on the pressure roller and prevent a lateral deflection of the pressure roller.

The present further relates to a pressure development method which comprises the steps of: exposing a photosensitive medium comprising a plurality of microcapsules which encapsulate imaging material to form a latent image; passing the photosensitive medium between a nip portion defined by at least one pressure roller and a backing member; and developing the photosensitive medium by applying pressure on a surface of the photosensitive medium by applying a force onto a block-like member located above the pressure roller which is transferred to the pressure roller, the pressure being sufficient to rupture selected microcapsules to release imaging material, and the block-like member being adapted to prevent or lateral deflection of the pressure roller.

### BRIEF DESCRIPTION OF THE DRAWINGS

FIG. 1A schematically shows an image-forming device;

FIG. 1B schematically shows an example of a pressure applying system for the image-forming device of FIG. 1A;

FIGS. 2A and 2B respectively illustrate a large pressure roller and a small pressure roller, and show how development pressure requirements differ between the large pressure roller and the small pressure roller;

FIG. 3A illustrates a pressure development apparatus in accordance with a first embodiment of the present invention;

FIG. 3B illustrates a pressure development apparatus in accordance with a second embodiment of the present invention;

FIGS. 3C and 3D illustrate features of the pressure roller of the present invention;

FIG. 3E illustrates a variation of the pressure development apparatus of FIG. 3A or FIG. 3B;

FIG. 4A illustrates a pressure development apparatus in accordance with a further embodiment of the present invention;

FIG. 4B is a side view of the rollers of the pressure development apparatus of FIG. 4A;

FIG. 4C is a top view of the rollers of FIG. 4B;

FIGS. 5A and 5B respectively illustrate a side view and a top view of another embodiment of the rollers for the pressure development apparatus of FIG. 4A;

FIG. 6 illustrates a pressure development apparatus in accordance with a still further embodiment of the present invention; and

FIG. 7 illustrates a pressure development apparatus in accordance with a still further embodiment of the present invention.

### DETAILED DESCRIPTION OF THE INVENTION

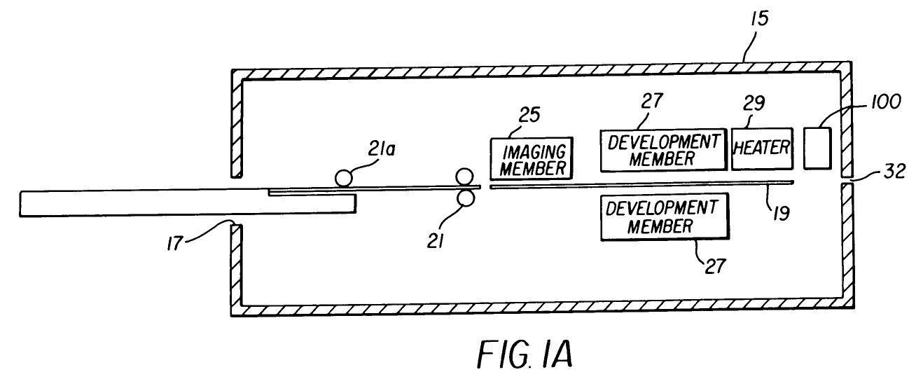

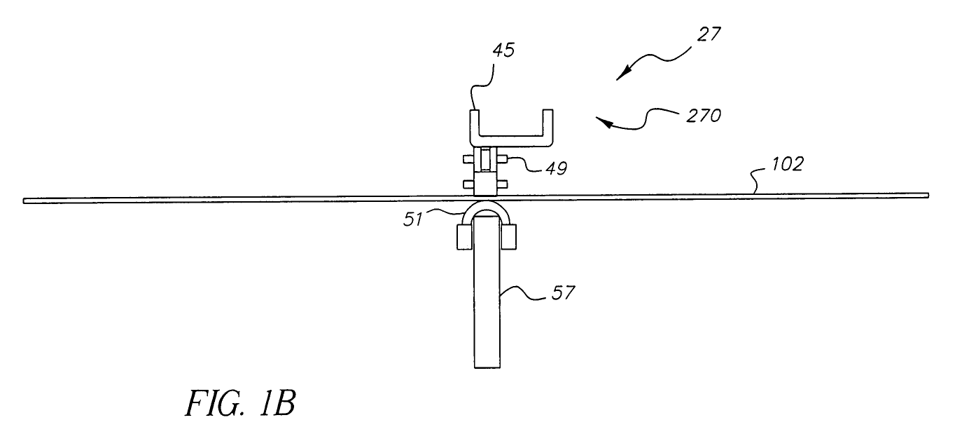

Referring now to the drawings, wherein like reference numerals represent identical or corresponding parts throughout the several views, FIG. 1A is a schematic view of an image-forming device 15 pertinent to the present invention. Image forming device 15 could be, for example, a printer that includes an opening 17 that is adapted to receive a cartridge containing photosensitive media. As described in U.S. Pat. No. 5,884,114, the cartridge could be a light-tight cartridge in which photosensitive sheets are piled one on top of each other. When inserted into image forming device 15, a feed mechanism that includes, for example, a feed roller 21a in image forming device 15, working in combination with a mechanism in the cartridge, cooperate with each other to pull one sheet at a time from the cartridge into image forming device 15 in a known manner. Although a cartridge type arrangement is shown, the present invention is not limited thereto. It is recognized that other methods of introducing media into to the image-forming device such as, for example, individual media feed or roll feed are applicable to the present invention.

Once inside image forming device 15, photosensitive media travels along media path 19, and is transported by, for example, drive rollers 21 connected to, for example, a driving mechanism such as a motor. The photosensitive media will pass by an imaging member 25 in the form of an imaging head that could include a plurality of light emitting elements (LEDs) that are effective to expose a latent image on the photosensitive media based on image information. After the latent image is formed, the photosensitive media is conveyed past a processing assembly or a development member 27. Processing assembly 27 could be a pressure applicator, pressure assembly or pressure development apparatus, wherein an image such as a color image is formed based on the image information by applying pressure to microcapsules having imaging material encapsulated therein to crush the microcapsules. The pressure could be applied by way of spring-loaded balls, micro wheels, micro rollers, rolling pins, etc.

FIG. 1B schematically illustrates an example of a pressure applicator 270 for pressure development apparatus 27. In the example of FIG. 1B, pressure applicator 270 is a crushing roller arrangement that provides a point contact on photosensitive medium 102. More specifically, pressure applicator 270 includes a support 45 that extends along a width-wise direction of photosensitive medium 102. Moveably mounted on support 45 is a crushing roller arrangement 49 that is adapted to move along the length of support 45, i.e., across the width of photosensitive medium 102. Crushing roller arrangement 49 is adapted to contact one side of photosensitive medium 102. A backing member in the form of a beam or roller type member 51 is positioned on an opposite side of photosensitive medium 102 and can be provided on a support or spring member 57. Beam or roller type member 51 is positioned so as to contact the opposite side of photosensitive medium 102 and is located opposite crushing roller arrangement 49. Beam or roller type member 51 and crushing roller arrangement 49 when in contact with photosensitive medium 102 on opposite sides provide a point contact on photosensitive medium 102. Crushing roller arrangement 49 is adapted to move along a width-wise direction of photosensitive material 102 so as to crush microcapsules and release coloring material. Further examples of pressure applicators or crushing members are described in U.S. Pat. Nos. 6,483,575 and 6,229,558.

Within the context of the present invention, the imaging material comprises a coloring material (which is used to form images) or material for black and white media. After the formation of the image, the photosensitive media is conveyed past heater 29 (FIG. 1A) for fixing the image on the media. In a through-feed unit, the photosensitive media could thereafter be withdrawn through an exit 32. As a further option, image-forming device 15 can be a return unit in which the photosensitive media is conveyed or returned back to opening 17.

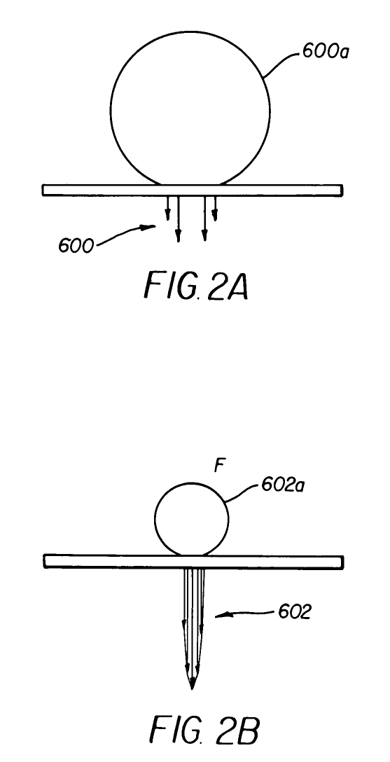

FIGS. 2A and 2B respectively illustrate a large pressure roller 600a and small pressure roller 602a, and show how development pressure differs between the large pressure roller and the small pressure roller. More specifically, as shown in a comparison between FIGS. 2A and 2B, a maximum print pressure under a cylindrical print head or pressure roller increases from that illustrated by arrows 600 (for large pressure roller 600a) in FIG. 2A, to that illustrated by arrows 602 (for small pressure roller 602a) in FIG. 2B as the cylindrical print head or pressure roller radius is reduced. The embodiment shown in FIG. 2B illustrates that placing a small roller on the image side of the media provides for an increase in pressure. Therefore, the pressure on the microcapsules can be determined by or based on the size of the small roller. The following calculation shows how to achieve a desired developing pressure of between 60 to 110 MPa, and preferably 100 MPa (which is used as a non-limiting example of a preferred development pressure). The contact radius, a, between a small roller and a top surface of the media is noted by the following Equation (1):

$$a = 2 \sqrt{\frac{p ( 1 - {v}^{2} )}{π lE}} r \qquad ( 1 )$$

wherein l is the contact length in the axial direction of the roller. The spring load P is related to the required pressure through the following Equation (2):

$$\frac{2 P}{π al} = \frac{2 P}{2 π l \sqrt{\frac{P}{π {lE}^{*}} R}} = \frac{\sqrt{P}}{\sqrt{\frac{1}{{E}^{*}} π lR}} = {p}_{max} = 100 MPa \qquad ( 2 )$$

where E* is a material parameter defined by the Poisson's ratio vI, V₂ and Youngs modulus E₁, E₂ of the roller and the imaging materials, respectively:

$$\frac{1}{{E}^{*}} = \frac{1 - {v}_{1}^{2}}{{E}_{1}} + \frac{1 - {v}_{2}^{2}}{{E}_{2}} \qquad ( 3 )$$

Equation (2) leads to Equation (4):

$$P = {( {p}_{max} )}^{2} \frac{π lR}{{E}^{*}} = {100}^{2} \frac{π lR}{{E}^{*}} \qquad ( 4 )$$

Since the radius R of the small roller 602a is much smaller than the radius of the large roller 600a, the spring load, P required to deliver the desired printing pressure of 100 MPa is significantly reduced. This also leads to lower torque requirements of the motor and ease of lateral deflection control of the printing rollers.

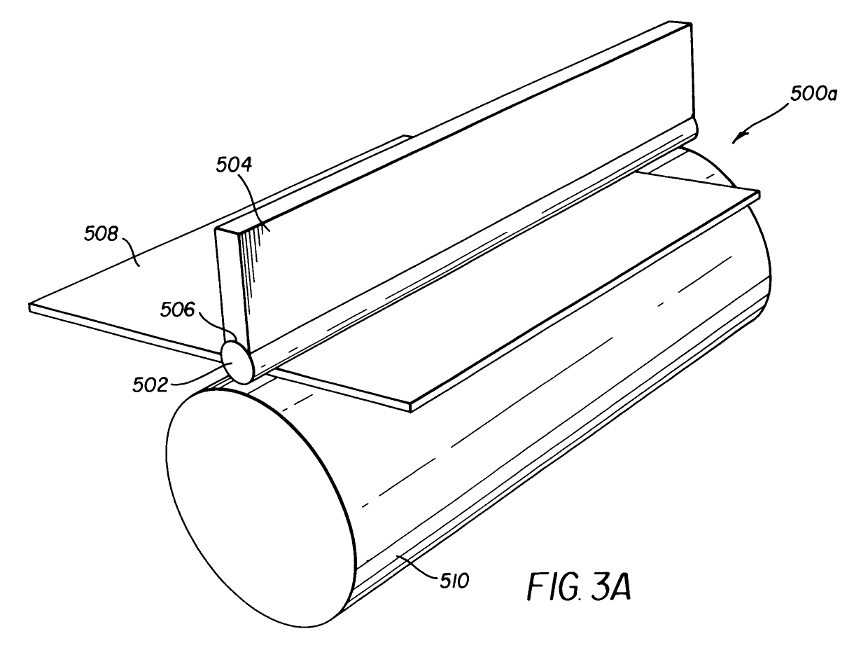

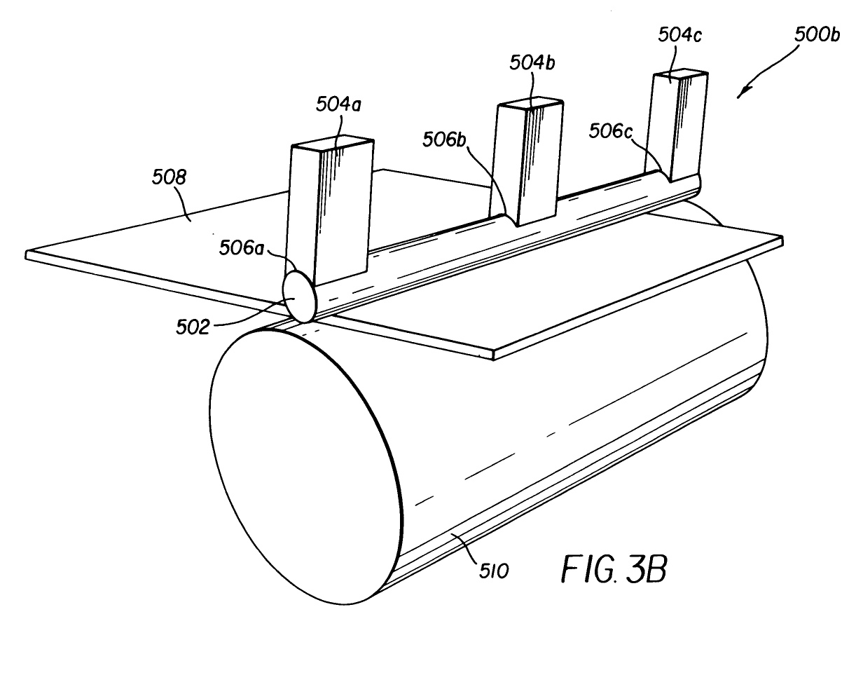

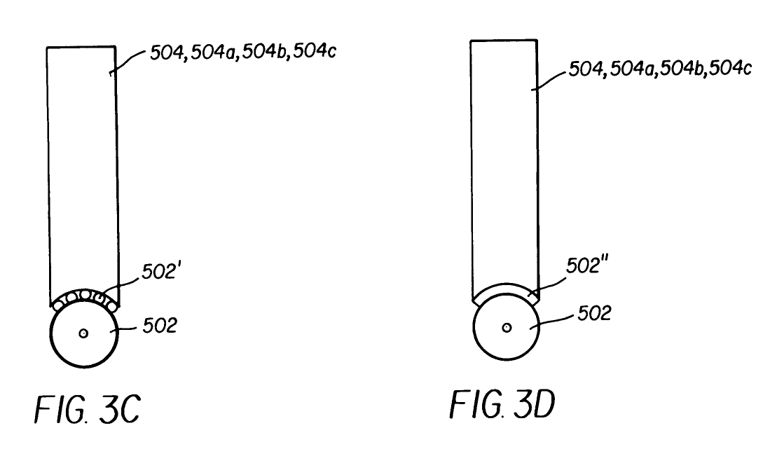

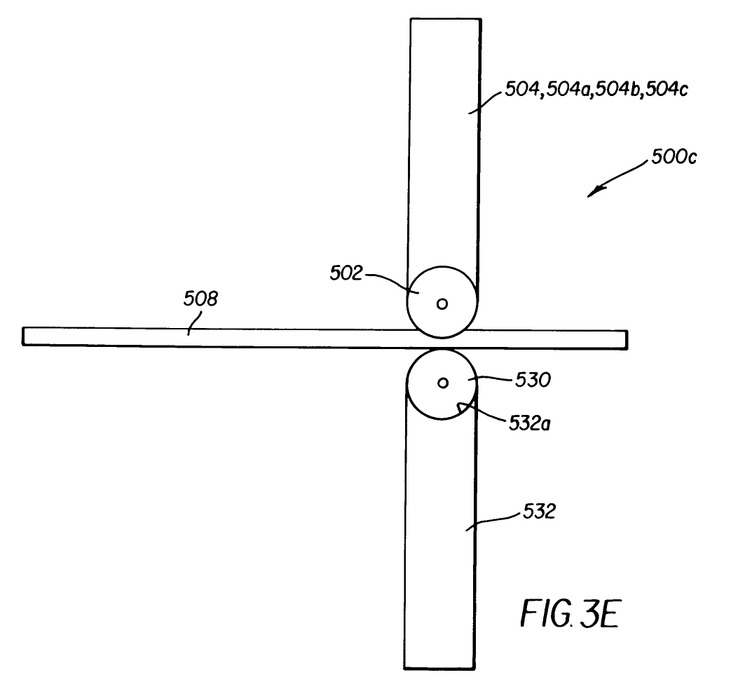

The present invention takes advantage of the above properties of a small roller by providing for a pressure development apparatus 500a as shown in FIG. 3A for an image forming device as illustrated in FIGS. 1A and 1B. As shown in FIG. 3A, pressure development apparatus 500a includes a small diameter pressure roller 502 that has a roller width (in a direction transverse to the direction of movement of media) which is at least approximately equal to a media width of media 508 to be developed. Pressure roller 502 is adapted to apply pressure onto a surface of media 508 to be developed through the use of a block-like, beam-like or plate-like member 504. That is, as shown in FIG. 3A, block-like member 504 is mounted on top of the pressure roller in a manner which permits a rotation of small roller 502 relative to block-like member 504. To achieve this, block-like member 504 can be movably mounted on opposing walls of the image forming device and on top of the small pressure roller 502 (which can also be movably mounted on the opposing walls of the image forming device) in a manner which permits a transfer of force from member 504 to roller 502, and permits a rotation of roller 502 relative to member 504. As also shown in FIG. 3A, block-like member 504 includes a curved section 506 adjacent to an outer circumference of pressure roller 502 that matches a curvature of pressure roller 502 and partially surrounds the outer circumference of pressure roller 502.

A backing member 510 which in the example of FIG. 3A is a roller can be located on an opposing side of pressure roller 502 such that a nip portion for media to be developed is defined between pressure roller 502 and backing member 510.

With the arrangement of FIG. 3A, a force can be applied to block-like member 504 which is subsequently transferred to pressure roller 502. This applies pressure to media 508 at the nip portion to cause the development of media by selectively rupturing microcapsules on media 508.

As also shown in FIG. 3A, in one embodiment, block-like member 504 is a single block-like member that approximately matches the roller width of pressure roller 502 to prevent a deflection of pressure roller 502 in a width-wise direction and equalize the pressure applied by pressure roller 502 in the width-wise direction.

The arrangement of FIG. 3A provides the advantages of both point processing and line processing arrangements. It uses line processing so that the printing speed is fast by having a pressure roller 502 whose width approximates the media width of the media to be developed, and incorporates roller 502 of small diameter so that a relatively low load is needed to provide the high pressure required for processing.

FIG. 3B illustrates a further embodiment of a pressure development apparatus in accordance with the present invention. Pressure development apparatus 500b of FIG. 3B differs from pressure development apparatus 500a of FIG. 3A with respect to the block like member. That is, in FIG. 3B, block-like member 504 is in the form of spaced-apart multiple block-like members 504a, 504b, and 504c. Although the embodiment of FIG. 3B illustrates 3 block-like members (504a, 504b and 504c) provided along a width-wise direction of media 508, the invention is not limited thereto, and any number of block-like members in accordance with their width can be utilized within the context of the present invention. Each of block-like members 504a, 504b, and 504c have a respective curved section 506a, 506b, and 506c that approximates the curvature of roller 502. Therefore, in the embodiment of FIG. 3B, the advantage of small roller 502 is realized and at the same time, multiple block-like members 504a, 504b and 504c are spaced in a manner in which pressure applied to roller 502 is equalized and a deflection of roller 502 is prevented.

Although the above has been described as illustrating that block like members 504, 504a, 504b, 504c are closely positioned on top of or adjacent to roller 502 to contact roller 502 while at the same time permit a rotation of roller 502 relative to the block-like member, it is noted that the present invention can provide for roller bearings 502′ (FIG. 3C) or additional layers of material 502″ (FIG. 3D) between roller 502 and block-like member 504, as well as roller 502 and block-like members 504a, 504b and 504c to facilitate the rotation of roller 502. As examples, dry rubber bearings such as a layer of nylon, a PTFE (Polythetrafluoroethylene, Trade name Teflon) or a porous bronze layer filled with PTFE (like Glycodur) could be used. It is also noted that the present invention can provide for surface treatments or coatings on roller 502 and/or block-like member 504, as well as on roller 502 and/or block-like members 504a, 504b and 504c to facilitate the rotation of roller 502.

FIG. 3E illustrates a further embodiment of a pressure development apparatus in accordance with the present invention. In FIG. 3E, pressure development apparatus 500c includes pressure roller 502 as shown in FIGS. 3A and 3B. Pressure development apparatus 500c can also include either a single block-like member 504 (FIG. 3A) or multiple block-like members 504a, 504b, and 504c as illustrated in FIG. 3B. Pressure roller 500c differs from the previous pressure development apparatuses with respect to the backing member. In the embodiment of FIG. 3C, the backing member is in a form of a further block-like member 532 which extends along a width-wise direction of media 508 (in a direction transverse to the direction of movement of the media), and is mounted adjacent to a further small diameter roller 530 which also extends along the width-wise direction of media 508. With this arrangement, pressure is maximized and at the same time, the combination of the block-like members (504 504a, 504b, 504c, 532) prevent the lateral deflection of rollers 502 and 530.

It is noted that block-like member 532 also includes a curved section 532a which approximates the curvature of roller 530. Block-like member 532 also is either mounted in close proximately to roller 530 to contact roller 530 while permitting a rotation of roller 530 relative to block-like member 532. As a further option, multiple bearings can be inserted between roller 530 and block-like member 532.

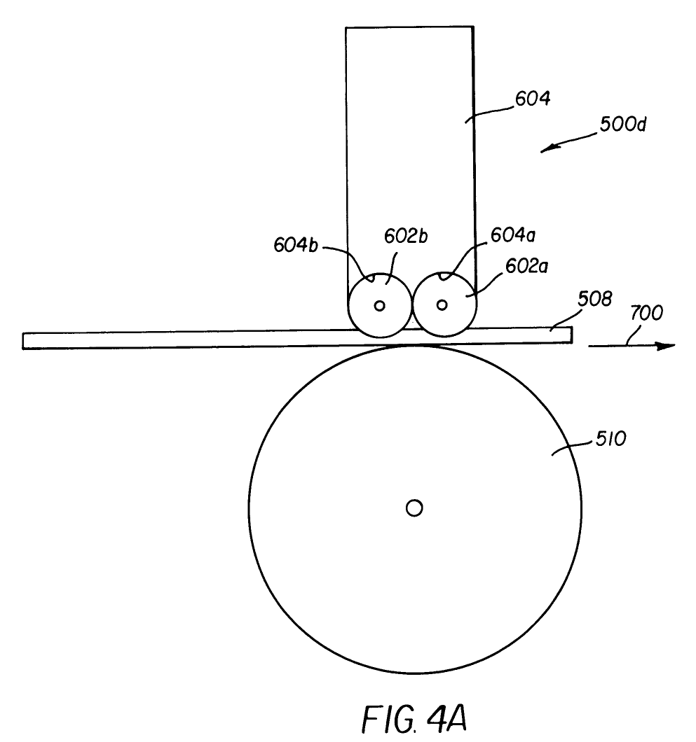

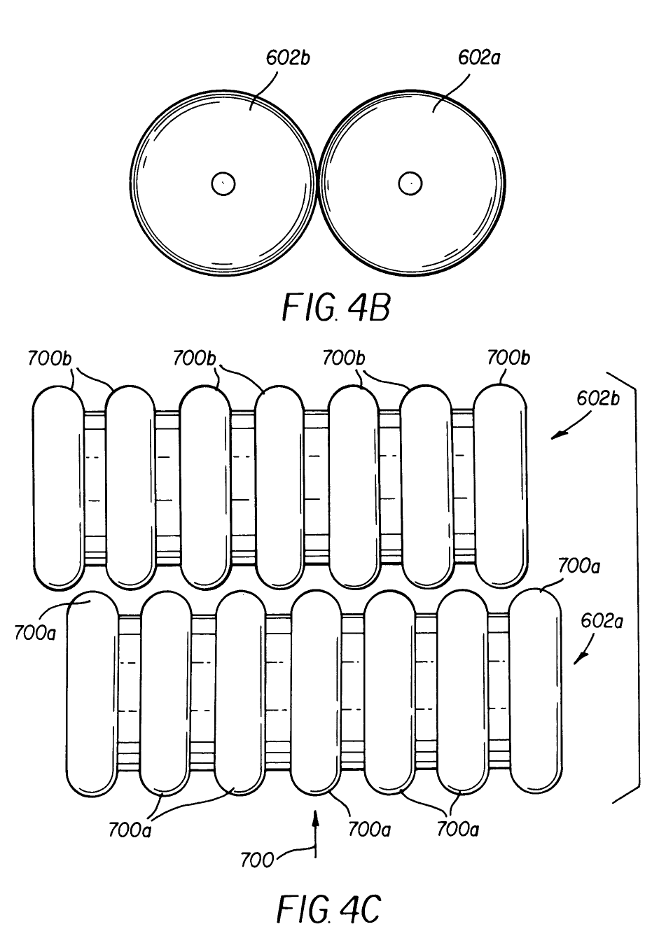

In a still further embodiment of the present invention as shown in FIG. 4A, rather than having a single small roller 502, two small pressure rollers 602a, 602b are provided one behind the other with respect to a direction of travel 700 of media 508 to be developed. Block-like member 604 is similar to block-like member 504, but rather than having a single curved section 506 which approximates the outer curvature of the roller, block-like member 604 includes two curved sections 604a, 604b. Curved section 604a partially surrounds roller 602a, while curved section 604b partially surrounds roller 602b. Pressure development apparatus 500d of FIG. 4A works similar to the previous pressure development apparatuses in that a nip portion is defined between the rollers and the backing member. However, rather than a single nip portion, two offset or spaced nip portions can be defined since two rollers 602a, 602b, one behind the other are utilized. Further, block-like member 604 could be similar to block-like member 504 of FIG. 3A and extend along the width-wise direction of the media, or can be multiple block-like members as shown in FIG. 3B. However, in either case block-like member 604 provides the advantage of achieving a force onto rollers 602a, 602b to provide a maximum desired force on media 508 and prevent a lateral deflection of rollers 602a, 602b.

Therefore, in the embodiment of FIG. 4A, block-like member 604 includes first curved section 604a for roller 602a and second curved section 604b for roller 602b. Each of curved sections 604a, 604b approximate the respective outer curvature of rollers 602a, 602b. Further, block-like member 604 is placed against or on top of roller 602a, 602b, or in an alternative embodiment, bearings can be provided between the outer surfaces of rollers 602a, 602b and curved sections 604a, 604b.

FIG. 4B is a side view of rollers 602a, 602b, while FIG. 4C is a top view of rollers 602a, 602b. As shown in the top view of FIG. 4C, the direction of movement of media is illustrated by arrow 700 and in order to maximize the crushing ability of the rollers, the rollers are offset with respect to each other in the manner illustrated in FIG. 4C. To further maximize the crushing ability, each of rollers 602a and 602b could have a plurality of outer ring members 700a for roller 602a and a plurality of outer ring members 700b for roller 602b. The outer ring members 700a, 700b are positioned in a space manner as shown in FIG. 4C, such that an outer ring 700b for roller 602b is located in a space between two outer rings 700a of roller 602a; while an outer ring 700a for roller 602a is located in a space between two outer rings 700b of roller 602b. Outer rings 700a, 700b are designed to completely surround respective rollers 602a, 602b and are located in the offset manner as shown in FIG. 4C to assure that pressure is applied on the entire or maximum amount of surface of photographic media.

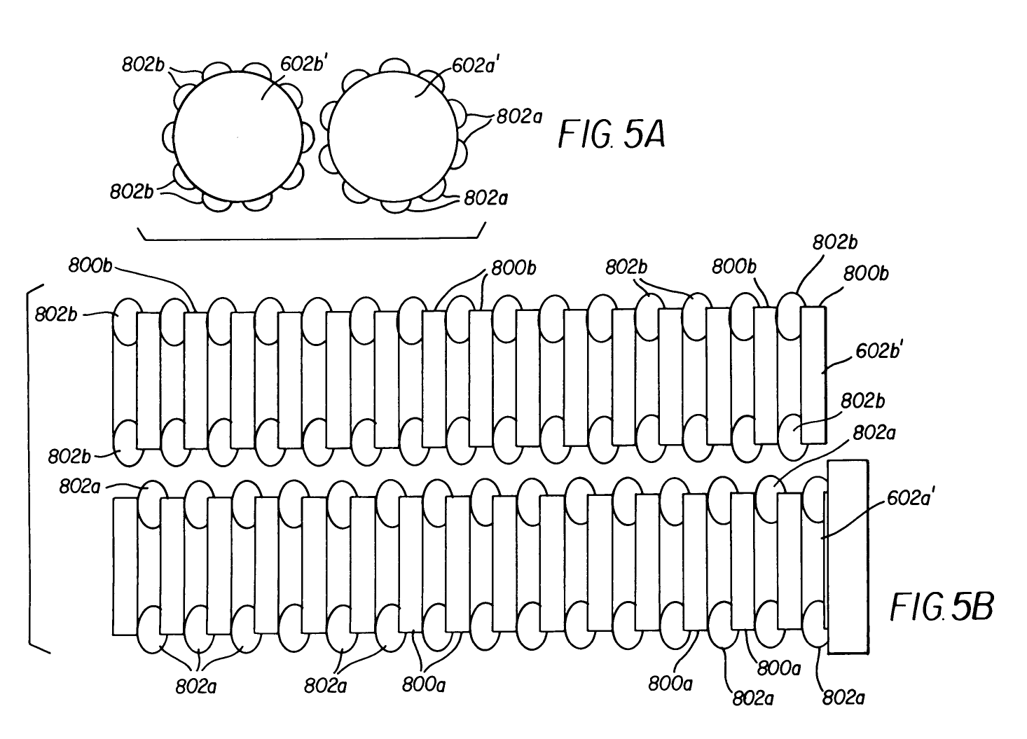

FIGS. 5A and 5B illustrate a further embodiment for the multiple rollers shown in FIG. 4A. More specifically, FIG. 5A is a side view of a roller 602a′ and a roller 602b′, while FIG. 5B is top view of rollers 602a′ and 602b′. Rollers 602a′ and 602b′ are designed to include a plurality of spaced segments 800a for roller 602a′ and 800b for roller 602b′, wherein protruding round members or bearing-like members 802b are provided in the space bound by the spaced segments. More specifically, as shown in FIG. 5B, for roller 602a′, a protruding round member 802a is located between two spaced segments 800a, 800a, while for roller 602b′ a protruding round member 802b is provided between two spaced segments 800b, 800b. The protruding round members are located at distinct locations around the entire periphery of each of rollers 602a′ and 602b′.

Further, as shown in FIG. 5B, protruding round members 802a of roller 602a′ are offset from protruding round members 802b of 602b,′ such that the placing of one roller behind the other (in a direction of movement of the media) assures that the entire surface area or maximum amount of surface area of the media passing below the rollers would be acted upon the protruding round members.

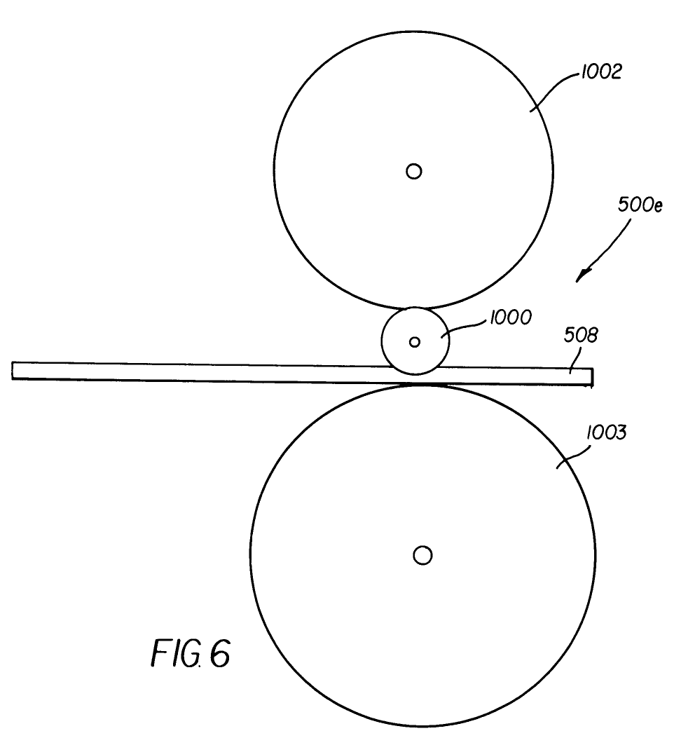

FIG. 6 is a further embodiment of a pressure application apparatus in accordance with the present invention. In the embodiment of FIG. 6, pressure development apparatus 500e includes a first roller 1000 having a roller width which is at least approximately equal to a media width of media to be developed. First roller 1000 defines a first diameter and is adapted to apply pressure on the surface of media 508 to be developed. A second roller 1002 has a diameter that is greater than first roller 1000 and a width in a direction transverse to the direction of movement of media that matches the width of first roller 1000. Second roller 1002 is provided on top of first roller 1000 and is adapted to equalize the pressure applied by first roller 1000 in a width-wise direction to minimize a deflection of first roller 1000 in a width-wise direction. In the embodiment of FIG. 6, a backing roller 1003 is provided opposite small roller 1000 such that a nip portion is created between small roller 1000 and backing roller 1003. This also provides the advantages of the previous embodiment in that the force applied by small roller 1000 is maximized along an entire width of media 508 while large roller 1002 serves to minimize deflection of roller 1000.

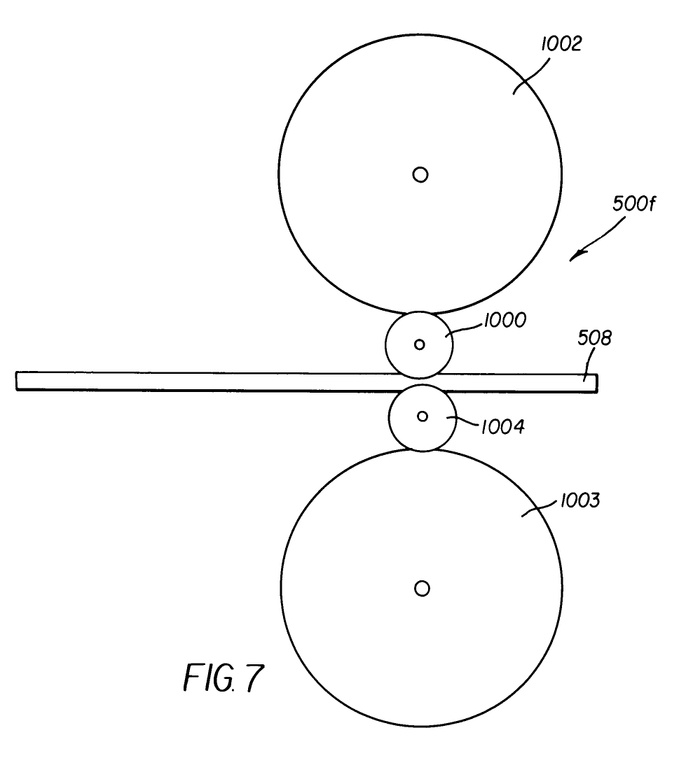

FIG. 7 is a still further embodiment of a pressure development apparatus in accordance with the present invention. In FIG. 7, pressure development 500f apparatus includes small roller 1000 and large roller 1002 provided on top of small roller 1000 as in the embodiment of FIG. 6. In the embodiment of FIG. 7, rather than having a single large roller 1003 as a backing member, the embodiment shows a smaller backing roller 1004 opposite small roller 1000 with a larger backing roller 1003 making contact with smaller backing roller 1004. Thus, with the arrangement of FIG. 7, a nip portion is created between small rollers 1000 and 1004, while the force applied by small roller 1000 is maximized onto media 508. Further, large rollers 1002, 1003 serve to minimize deflection of small rollers 1000, 1004. Also, since small rollers 1000 and 1004 and rollers 1002, 1003 extend along the width-wise direction of media 508, a more rapid processing of the media can be assured. That is, the arrangement provides the advantage of a line processing so printing speed is fast while incorporating a small diameter roller so that a relatively low load is needed to provide the high pressure required for processing.

The invention has been described in detail with particular reference to certain preferred embodiments thereof, but it will be understood that variations and modifications can be effected within the spirit and scope of the invention.

1. A pressure development apparatus comprising:
a pressure roller having a roller width which is at least approximately equal to a media width of media to be developed, said pressure roller being adapted to apply a pressure onto a surface of media to be developed; and
at least one block-like member mounted on top of said pressure roller, said block-like member having at least one curved section adjacent to an outer circumference of said pressure roller which matches a curvature of said pressure roller and partially surrounds the outer circumference of the pressure roller.

2. A pressure development apparatus according to claim 1, further comprising:
a backing member located on an opposing side of said pressure roller such that a nip portion for media to be developed is defined between said pressure roller and said backing member;
wherein a force applied to said at least one block-like member is transferred to said pressure roller to apply the pressure to the media at said nip portion and cause a development of said media.

3. A pressure development apparatus according to claim 1, wherein said pressure roller is rotatable relative to said block-like member.

4. A pressure development apparatus according to claim 1, wherein said block-like member is a single block like member which approximately matches the roller width of said pressure roller to prevent a deflection of said pressure roller in a width-wise direction and equalize the pressure applied by said pressure roller in said width-wise direction.

5. A pressure development apparatus according to claim 1, comprising a plurality of said block-like members provided in a spaced manner in a width-wise direction of said pressure roller to prevent a deflection of said pressure roller in the width-wise direction and equalize the pressure applied by said pressure roller in the width-wise direction.

6. A pressure development apparatus according to claim 1, further comprising at least one bearing member provided between said pressure roller and said curved section of said block-like member.

7. A pressure development apparatus according to claim 1, comprising at least two of said pressure rollers provided one behind the other with respect to a direction of travel of media to be developed, said block-like member comprising at least two of said curved sections which respectively match an outer circumference of each of said at least two pressure rollers.

8. A pressure development apparatus according to claim 7, wherein each of said at least two pressure rollers comprises ring like members which completely surround each of said pressure rollers and are provided in a spaced manner along a width-wise direction of said pressure rollers.

9. A pressure development apparatus according to claim 8, wherein said at least two pressure rollers are positioned in an off-set manner in said width-wise direction so that the ring-like members on one of the at least two pressure rollers are off-set from the ring-like members on the other of said at least two pressure rollers.

10. A pressure development apparatus according to claim 7, wherein each of said at least two pressure rollers comprises protruding round members which are provided at distinct locations around a circumference of each of said at least two pressure rollers.

11. A pressure development apparatus according to claim 10, wherein said at least two pressure rollers are positioned in an off-set manner in said width-wise direction so that the protruding round members on one of the at least two pressure rollers are off-set from the protruding round members on the other of said at least two pressure rollers.

12. A pressure development method comprising the steps of:
exposing a photosensitive medium comprising a plurality of microcapsules which encapsulate imaging material to form a latent image;
passing the photosensitive medium between a nip portion defined by at least one pressure roller and a backing member; and
developing said photosensitive medium by applying pressure on a surface of said photosensitive medium by applying a force onto a block-like member located above said pressure roller which is transferred to said pressure roller, said pressure being sufficient to rupture selected microcapsules to release imaging material, said block-like member having at least one curved portion which matches a curvature of said at least one pressure roller and partially surrounds the at least one pressure roller.

13. A method according to claim 12, wherein said block-like member is a single block like member which approximately matches a roller width of said pressure roller to prevent a deflection of said pressure roller in a width-wise direction and equalize the pressure applied by said pressure roller in said width-wise direction.

14. A method according to claim 12, comprising a plurality of said block-like members provided in a spaced manner in a width-wise direction of said pressure roller to prevent a deflection of said pressure roller in a width-wise direction and equalize a pressure applied by said pressure roller in the width-wise direction.

15. A pressure development apparatus comprising:
a first roller having a roller width which is at least approximately equal to a media width of media to be developed, said first roller having a first diameter and being adapted to apply pressure onto a surface of media to be developed; and
a second roller located above said first roller and having a second diameter which is greater than the first diameter of said first roller, said second roller being adapted to equalize the pressure applied by the first roller in a width-wise direction and prevent a deflection of said first roller in said width-wise direction.

16. A pressure development apparatus according to claim 15, further comprising:
a backing member located on an opposing side of said first pressure roller such that a nip portion for media to be developed is defined between said first pressure roller and said backing member;
wherein a force applied to said second roller is transferred to said first roller to apply the pressure to the media at said nip portion and cause a development of said media.

17. A pressure development apparatus according to claim 16, wherein said backing member comprises a single backing roller.

18. A pressure development apparatus according to claim 16, wherein said backing member comprises a first small diameter backing roller which forms the nip portion with said first roller and a second larger diameter backing roller mounted adjacent to the first smaller diameter backing roller.

19. A pressure development apparatus comprising:
a pressure roller having a roller width which is at least approximately equal to a media width of media to be developed, said pressure roller being adapted to apply a pressure onto a surface of media to be developed;
a first block-like member mounted on top of said pressure roller, said first block-like member having a first curved section adjacent to an outer circumference of said pressure roller which matches a curvature of said pressure roller and partially surrounds the outer circumference of the pressure roller;
a backing roller which forms a nip portion with said pressure roller for a passage of media to be developed there-between; and
a second block-like member mounted adjacent to said backing roller, said second block-like member having a second curved section adjacent to an outer circumference of said backing roller which matches a curvature of said backing roller and partially surrounds the outer circumference of the backing roller.

20. A pressure development apparatus according to claim 19, wherein said first block like member is adapted to prevent a deflection of said pressure roller in a width-wise direction of said pressure roller, and said second block member is adapted to prevent a deflection of said backing roller in a width-wise direction of said backing roller.

21. A pressure development apparatus comprising:
a pressure roller having a roller width which is at least approximately equal to a media width of media to be developed, said pressure roller being adapted to apply a pressure onto a surface of media to be developed; and
at least one block-like member mounted on top of said pressure roller, said block-like member being adapted to provide a force on said pressure roller and prevent a lateral deflection of said pressure roller.

22. A pressure development method comprising the steps of:
exposing a photosensitive medium comprising a plurality of microcapsules which encapsulate imaging material to form a latent image;
passing the photosensitive medium between a nip portion defined by at least one pressure roller and a backing member; and
developing said photosensitive medium by applying pressure on a surface of said photosensitive medium by applying a force onto a block-like member located above said pressure roller which is transferred to said pressure roller, said pressure being sufficient to rupture selected microcapsules to release imaging material, said block-like member being adapted to prevent a lateral deflection of said pressure roller.
